(19) United States
(12) Patent Application Publication
(10) Pub. No.: US 2012/0260235 A1
(43) Pub. Date: Oct. 11, 2012

(54) RESPONSE SIMULATOR COMPUTING APPARATUSES AND METHODS THEREOF

(75) Inventors: Manjunath Krishnamurthy GUNDI, Bangalore (IN); Pallavi BOMMA, Bangalore (IN); Sandeep CHAUHAN, Bangalore (IN)

(73) Assignee: INFOSYS TECHNOLOGIES, LTD., Bangalore (IN)

(21) Appl. No.: 13/217,675

(22) Filed: Aug. 25, 2011

(30) Foreign Application Priority Data
Apr. 7, 2011 (IN) 1190/CHE/2011

(51) Int. Cl. G06F 9/44

(52) U.S. Cl. 717/124

(57) ABSTRACT

A method, non-transitory computer readable medium and apparatus that simulates responses includes obtaining one or more requests from two or more different types of interfaces for an application. Each of the one or more obtained requests is parsed to obtain one or more components. A simulated response is fetched based on the parsed one or more components for each of the one or more obtained requests. The fetched simulated response for each of the one or more obtained requests is provided to the corresponding one of the two or more different types of interfaces for the application. This technology provides a simple data driven simulation that is easily deployable and integrated into the existing development environments with customizable plug-in components.

This application claims the benefit of Indian Patent Application Filing No. 1190/CHE/2011, filed Apr. 7, 2011, which is hereby incorporated by reference in its entirety.

### FIELD

This technology generally relate to methods and systems for testing applications and, more particularly, to response simulator computing apparatuses and methods thereof.

### BACKGROUND

During the production of software applications, development and testing teams would like to test all interfaces to an application to verify their operation. Unfortunately, development and testing teams often may not have access to all sources necessary to properly test all interfaces to the application. For example, offshore development and testing teams may have difficulties accessing all sources necessary to properly test all interfaces to the application. Additionally, even when all sources are available and accessible by the interfaces to the application, connectivity issues during testing can occur negatively impacting testing of the application and reducing the productivity of the development and testing team. This inability to successfully access all sources with the interfaces to obtain all necessary responses can hamper the development of the application.

### SUMMARY

A method for simulating responses includes obtaining at a response simulator computing apparatus one or more requests from two or more different types of interfaces for an application. Each of the one or more obtained requests is parsed with the response simulator computing apparatus to obtain one or more components. A simulated response is fetched with the response simulator computing apparatus based on the parsed one or more components for each of the one or more obtained requests. The fetched simulated response for each of the one or more obtained requests is provided to the corresponding one of the two or more different types of interfaces for the application.

A non-transitory computer readable medium having stored thereon instructions for simulating responses comprising machine executable code which when executed by at least one processor, causes the processor to perform steps including obtaining one or more requests from two or more different types of interfaces for an application. Each of the one or more obtained requests is parsed to obtain one or more components. A simulated response is fetched based on the parsed one or more components for each of the one or more obtained requests. The fetched simulated response for each of the one or more obtained requests is provided to the corresponding one of the two or more different types of interfaces for the application.

A response simulator computing apparatus includes one or more processors and a memory coupled to the one or more processors which are configured to execute programmed instructions stored in the memory including obtaining one or more requests from two or more different types of interfaces for an application. Each of the one or more obtained requests is parsed to obtain one or more components. A simulated response is fetched based on the parsed one or more components for each of the one or more obtained requests. The fetched simulated response for each of the one or more obtained requests is provided to the corresponding one of the two or more different types of interfaces for the application.

This technology provides a number of advantages including providing more effective methods and devices that provide simulated responses to requests from all interfaces for an application during development and testing. With this technology, simulated responses are learned and stored with a virtual or other type of directory. During testing of an application, this directory or other index is utilized to fetch the simulated responses in response to the obtained requests from all of the interfaces for the application.

This technology provides a simple data driven simulation that is easily deployable and integrated into the existing development environments with customizable plug-in components. With this technology, development and testing teams always have access to all the necessary interfaces to properly test the application because they are provided by the response simulator computing apparatus. Additionally, since the response simulator computing apparatus is local to the testing computer device, offshore development and testing teams no longer need to be concerned about potential problems with connectivity during testing.

### BRIEF DESCRIPTION OF THE DRAWINGS

FIG. 1 is an environment with an exemplary response simulator computing apparatus;

FIG. 2 is a flow chart of an exemplary method for learning and storing simulated responses for an application;

FIG. 3 is a flow chart of an exemplary method for processing a web service request with the response simulator computing apparatus;

FIG. 4 is a flow chart of an exemplary method for processing a message request with the response simulator computing apparatus;

FIG. 5 is a partial screenshot and partial functional block diagram of an exemplary application accessing multiple interfaces at different remote locations; and

FIG. 6 is a partial screenshot and partial functional block diagram of the exemplary application accessing multiple interfaces at the exemplary simulated response testing apparatus

### DETAILED DESCRIPTION

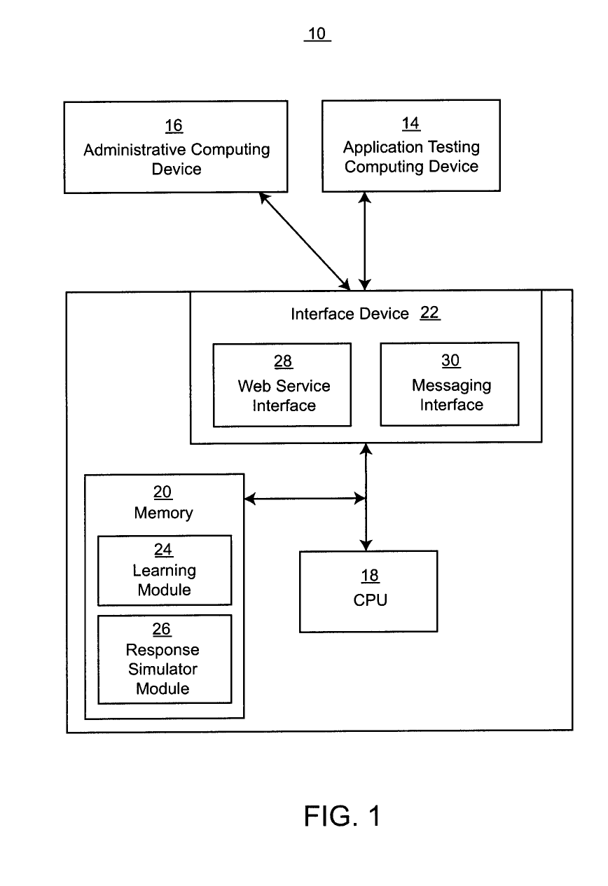

An environment 10 with an exemplary response simulator computing apparatus 12 is illustrated in FIG. 1. The environment 10 includes the simulated response testing apparatus 12, an application testing computing device 14, and an administrative computing device 16 which are all coupled together by one or more communication networks, although this environment can include other numbers and types of systems, devices, components, and elements in other configurations. This technology provides a number of advantages including providing more effective methods and devices that provide simulated responses to requests from all interfaces for an application during development and testing.

The response simulator computing apparatus 12 learns necessary simulated responses for requests from all interfaces to an application and identifies and provides these simulated responses during testing, although other numbers and types of systems could be used and other numbers and types of functions could be performed. The response simulator computing apparatus 12 includes a central processing unit (CPU) or processor 18, a memory 20, and an interface device 22 which are coupled together by a bus or other link, although other numbers and types of systems, devices, components, and elements in other configurations and locations can be used. The processor 18 in the response simulator computing apparatus 12 executes a program of stored instructions for one or more aspects of the present technology as described and illustrated by way of the examples herein, although other types and numbers of processing devices and logic could be used and the processor could execute other numbers and types of programmed instructions.

The memory 20 in the response simulator computing apparatus 12 stores these programmed instructions for one or more aspects of the present technology as described and illustrated herein, although some or all of the programmed instructions could be stored and executed elsewhere. In this example, the memory 20 comprises a learning module 24 utilized to learn all of the necessary simulated responses and a response simulator module 26 utilized to fetch and provide the appropriate simulated responses to all requests from the application being tested as illustrated and described herein, although the memory can comprise other types and numbers of modules and other databases, such as a searchable database for the learned simulated responses. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18 in the response simulator computing apparatus 12, can be used for the memory 20 in the response simulator computing apparatus 12.

The interface device 22 in the response simulator computing apparatus 12 is used to operatively couple and communicate between the response simulator computing apparatus 12 and the testing computing device 14 and the administrative computing device 16 via one or more of the communications networks, although other types and numbers of communication networks or systems with other types and numbers of connections and configurations can be used. In this example the interface device 22 includes a web service interface device 28 to manage web service requests and a messaging service interface to manage messaging requests, although other types and numbers of interface systems, devices, components, and elements in other configurations could be used. By way of example only, the one or more communications networks can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The application testing computing device 14 is used to develop and test an application, although other numbers and types of systems, devices, components, and elements in other configurations could be used to develop and test an application and other types and numbers of functions could be performed. The administrative computing device 16 is used to identify and provide information on the interfaces to the application and the simulated responses for all requests coming from these interfaces for the application, although other numbers and types of systems, devices, components, and elements in other configurations could be used and other types and numbers of functions could be performed.

The application testing computing device 14 and the administrative computing device 16 each include a central processing unit (CPU) or processor, a memory, and an interface or I/O system, which are coupled together by a bus or other link, although each could comprise other numbers and types of devices, elements, and components in other configurations.

Although examples of the response simulator computing apparatus 12, the application testing computing device 14, and the administrative computing device 16 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

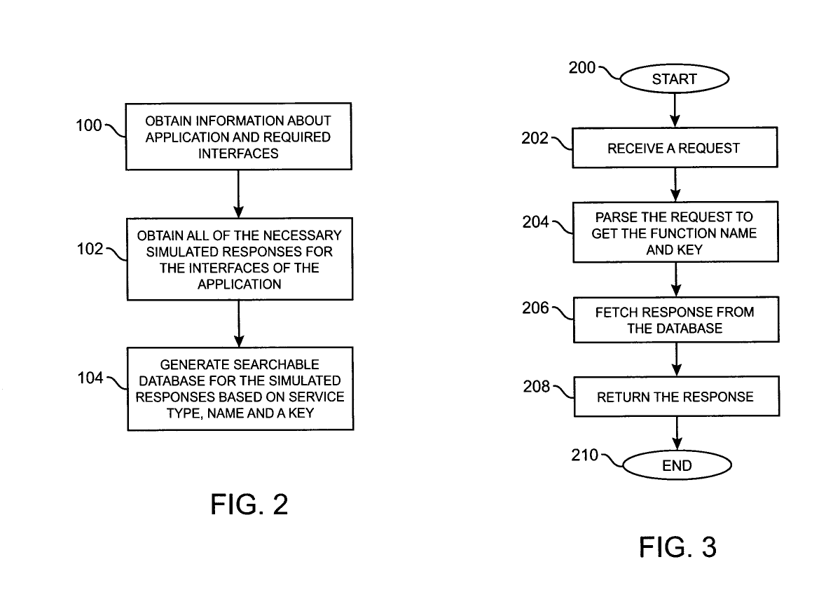

An exemplary method for simulating responses will now be described with reference to FIGS. 1-6. Referring more specifically to FIG. 2, an exemplary method for learning and storing simulated responses for an application is illustrated.

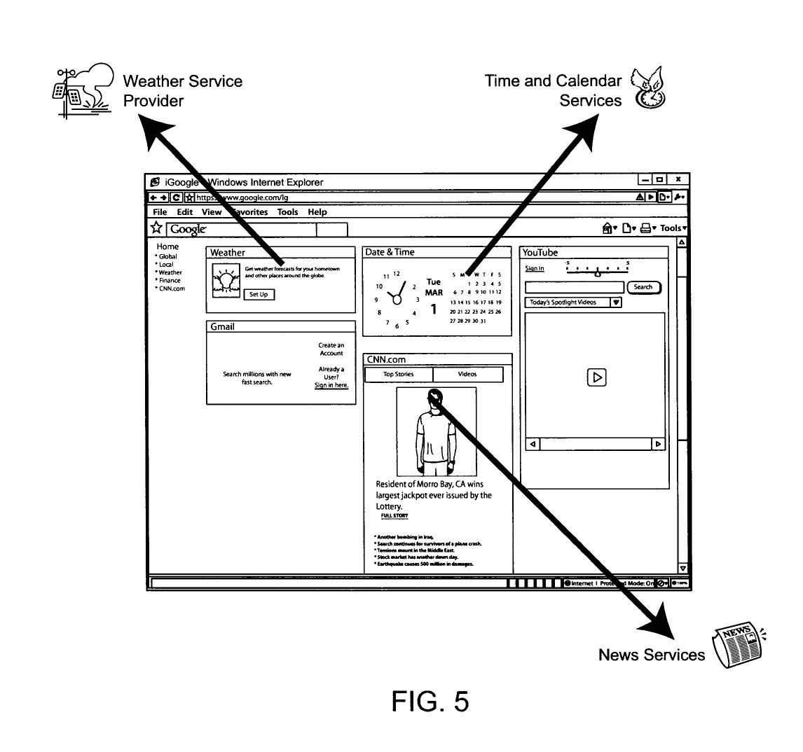

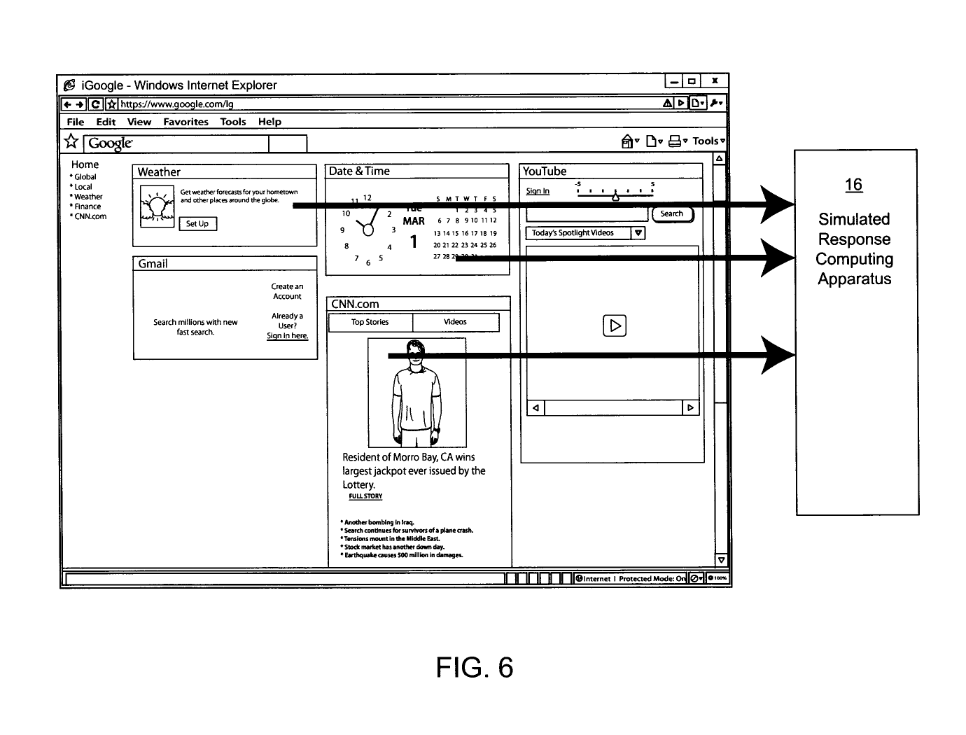

In step 100 the response simulator computing apparatus 12 obtains information from the administrative computing device 16 about the number and types of interfaces for the application under development and testing, although other types of information from other sources could be used. By way of example only, partial screenshots and partial functional block diagrams of multiple interfaces to an exemplary application undergoing testing is shown in FIGS. 5-6.

Referring back to FIG. 2, in step 102 the response simulator computing apparatus 12 obtains and stores in memory 20 all of the necessary simulated responses for all requests from the identified interfaces for the application from the administrative computing device 16, although other manners for obtaining or otherwise generating the simulated responses and other locations for storing the simulated responses could be used.

In step 104, the response simulator computing apparatus 12 generates a virtual directory to use to access and fetch the stored simulated responses based on a service type of request, name and key in an obtained request, although other manners for generating a directory or other index and other manners retrieving the stored simulated responses could be used.

Referring to FIG. 3, an exemplary method for processing a web service request with a simulated response starts at step 200. In step 202, the response simulator computing apparatus 12 receives a web service request at the web service interface 28 from one of the interfaces to the application being developed and tested by the application testing computing device 14.

In step 204, the response simulator computing apparatus 12 parses the obtained web service request to identify a service type, function name and key, although other types and numbers of components could be parsed from the request.

In step 206, the response simulator computing apparatus 12 fetches a stored simulated response to the web service request from a database in memory 20 based on the parsed service type, function name, and key, although other types and numbers of parsed components can be used to fetch the appropriate simulated response for the web service request. In this example, the response simulator computing apparatus 12 utilizes the generated virtual directory to identify and fetch the appropriate stored simulated response, although other manners for obtaining the simulated response to the request could be used.

In step 208, the response simulator computing apparatus 12 using the web service interface 28 returns the simulated response to the application executing on the application testing device 14. In step 210 this exemplary process with respect to this web service request ends.

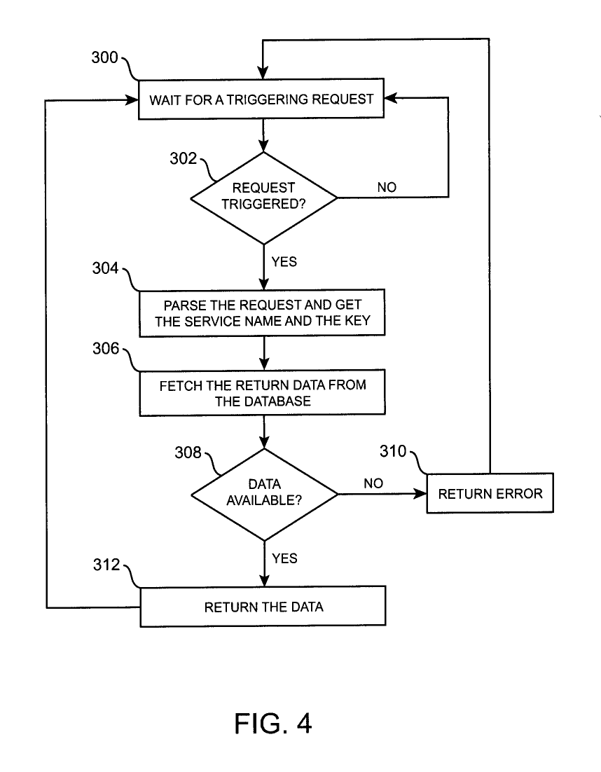

Referring to FIG. 4, an exemplary method for processing a message request with a simulated response is illustrated. In step 300, the response simulator computing apparatus 12 waits for a triggering message request at the messaging interface 30 from the application executing on the application testing computing device 14.

In step 302, the response simulator computing apparatus 12 determines whether a messaging request has been received. If in step 302, the response simulator computing apparatus 12 determines a messaging request has not yet been received, then the No branch is taken back to step 300. If in step 302, the response simulator computing apparatus 12 determines a messaging request has been received, then the Yes branch is taken to step 304.

In step 304, the response simulator computing apparatus 12 parses the obtained messaging request to identify a service type, service name and key, although other types and numbers of components could be parsed from the messaging request.

In step 306, the response simulator computing apparatus 12 fetches a simulated response to the messaging request from a database in memory 20 based on the parsed service type, service name, and key, although other types and numbers of parsed components can be used to fetch the appropriate simulated response for the messaging request. In this example, the response simulator computing apparatus 12 utilizes the generated virtual directory to identify and fetch the appropriate stored simulated response, although other manners for obtaining the simulated response to the request could be used.

In step 308, the response simulator computing apparatus 12 determines whether the appropriate simulated response is available. If in step 308 the response simulator computing apparatus 12 determines the appropriate simulated response is not available, then the No branch is taken to step 310. In step 310, the response simulator computing apparatus 12 returns an error message to the application executing on the application testing computing device 14.

If in step 308 the response simulator computing apparatus 12 determines the appropriate simulated response is available, then the Yes branch is taken to step 312. In step 312, the response simulator computing apparatus 12 using the messaging interface provides the fetched simulated response to the application executing on the application testing computing device 14 and then returns to step 300.

Accordingly, as illustrated and described herein this technology provides more effective methods and devices to provide simulated responses to requests from all interfaces for an application during development and testing. With this technology, simulated responses are learned and stored with a virtual or other type of directory. During testing of an application, this directory or other index is utilized to fetch the simulated responses in response to the obtained requests from all of the interfaces for the application.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for simulating responses, the method comprising:
obtaining at a response simulator computing apparatus one or more requests from two or more different types of interfaces for an application;
parsing with the response simulator computing apparatus each of the one or more obtained requests to obtain one or more components;
fetching with the response simulator computing apparatus a simulated response based on the parsed one or more components for each of the one or more obtained requests; and
providing with the response simulator computing apparatus the fetched simulated response for each of the one or more obtained requests to the corresponding one of the two or more different types of interfaces for the application.

2. The method set forth in claim 1 wherein the obtaining further comprises obtaining at the response simulator computing apparatus one or more web service requests.

3. The method as set forth in claim 2 wherein the parsing further comprises parsing with the response simulator computing apparatus the one or more web service requests to obtain a service type, function name, and key.

4. The method as set forth in claim 1 wherein the obtaining further comprises obtaining at the response simulator computing apparatus one or more web service requests.

5. The method as set forth in claim 4 wherein the parsing further comprises parsing with the response simulator computing apparatus the messaging request to identify a service type, service name and key.

6. The method as set forth in claim 1 further comprising:
learning at the response simulator computing apparatus the simulated response for substantially all of the requests from the two or more different types of interfaces for the application; and
storing with the response simulator computing apparatus the learned simulated response for substantially all of the requests.

7. The method as set forth in claim 6 further comprising creating with the response simulator computing apparatus a virtual directory between substantially all of the requests from the two or more different types of interfaces for the application and each of the stored simulated responses, wherein the fetching utilizes the virtual directory to obtain the simulated response based on the parsed one or more components for each of the requests.

8. A non-transitory computer readable medium having stored thereon instructions for simulating responses comprising machine executable code which when executed by at least one processor, causes the processor to perform steps comprising:
obtaining one or more requests from two or more different types of interfaces for an application;
parsing each of the one or more obtained requests to obtain one or more components;
fetching a simulated response based on the parsed one or more components for each of the one or more obtained requests; and
providing the fetched simulated response for each of the one or more obtained requests to the corresponding one of the two or more different types of interfaces for the application.

9. The medium set forth in claim 8 wherein the obtaining further comprises obtaining one or more web service requests.

10. The medium as set forth in claim 9 wherein the parsing further comprises parsing the one or more web service requests to obtain a service type, function name, and key.

11. The medium as set forth in claim 8 wherein the obtaining further comprises obtaining one or more web service requests.

12. The medium as set forth in claim 11 wherein the parsing further comprises parsing the messaging request to identify a service type, service name and key.

13. The medium as set forth in claim 8 further comprising:
learning the simulated response for substantially all of the requests from the two or more different types of interfaces for the application; and
storing the learned simulated response for substantially all of the requests.

14. The medium as set forth in claim 13 further comprising creating a virtual directory between substantially all of the requests from the two or more different types of interfaces for the application and each of the stored simulated responses, wherein the fetching utilizes the virtual directory to obtain the simulated response based on the parsed one or more components for each of the requests.

15. A response simulator computing apparatus comprising:
one or more processors;
a memory coupled to the one or more processors which are configured to execute programmed instructions stored in the memory comprising:
obtaining one or more requests from two or more different types of interfaces for an application;
parsing each of the one or more obtained requests to obtain one or more components;
fetching a simulated response based on the parsed one or more components for each of the one or more obtained requests; and
providing the fetched simulated response for each of the one or more obtained requests to the corresponding one of the two or more different types of interfaces for the application.

16. The apparatus set forth in claim 15 wherein the one or more processors is further configured to execute programmed instructions stored in the memory for the obtaining further comprising obtaining one or more web service requests.

17. The apparatus as set forth in claim 16 wherein the one or more processors is further configured to execute programmed instructions stored in the memory for the parsing further comprising parsing the one or more web service requests to obtain a service type, function name, and key.

18. The apparatus as set forth in claim 15 wherein the one or more processors is further configured to execute programmed instructions stored in the memory for the obtaining further comprising obtaining one or more web service requests.

19. The apparatus as set forth in claim 18 wherein the one or more processors is further configured to execute programmed instructions stored in the memory for the parsing further comprising parsing the messaging request to identify a service type, service name and key.

20. The apparatus as set forth in claim 15 wherein the one or more processors is further configured to execute programmed instructions stored in the memory further comprising:
learning the simulated response for substantially all of the requests from the two or more different types of interfaces for the application; and
storing the learned simulated response for substantially all of the requests.

21. The apparatus as set forth in claim 20 wherein the one or more processors is further configured to execute programmed instructions stored in the memory further comprising creating a virtual directory between substantially all of the requests from the two or more different types of interfaces for the application and each of the stored simulated responses, wherein the fetching utilizes the virtual directory to obtain the simulated response based on the parsed one or more components for each of the requests.
